(19) United States
(12) Patent Application Publication
(10) Pub. No.: US 2026/0170100 A1
(43) Pub. Date: Jun. 18, 2026

(54) USER INFORMATION SBT-ING APPARATUS, SYSTEM, CONTROL METHOD OF USER INFORMATION SBT-ING APPARATUS, AND NON-TRANSITORY COMPUTER-READABLE STORAGE MEDIUM

(71) Applicant: NEC Corporation, Tokyo (JP)

(72) Inventors: Eiji KANEKO, Tokyo (JP); Yoshitomo WARASHINA, Tokyo (JP); Yasuhiko YOSHIDA, Tokyo (JP); Kazuma KUNIYOSHI, Tokyo (JP)

(73) Assignee: NEC Corporation, Tokyo (JP)

(21) Appl. No.: 19/405,628

(22) Filed: Dec. 2, 2025

(30) Foreign Application Priority Data
Dec. 16, 2024 (JP) 2024-219570

(51) Int. Cl. G06F 21/10

(52) U.S. Cl. CPC G06F 21/1084

(57) ABSTRACT

A user information SBT-ing apparatus includes an issuing means and a guaranteeing means. The issuing means that issues to a user as an owner, based on user information, the user information being information generated by a first server that provides a first service and related to a situation of the user who receives the first service, an SBT corresponding to the user information. The guaranteeing means enables a second server, the second server providing a second service, to perform a display guaranteeing that the user owns the SBT.

### INCORPORATION BY REFERENCE

This application is based upon and claims the benefit of priority from Japanese Patent Application No. 2024-219570, filed on Dec. 16, 2024, the disclosure of which is incorporated herein in its entirety by reference.

### TECHNICAL FIELD

The present disclosure relates to a user information SBT-ing apparatus, a system, a control method of a user information SBT-ing apparatus, and a non-transitory computer-readable storage medium.

### BACKGROUND ART

There exists a technology for issuing a token related to a device used by a user.

For example, Patent Literature 1 (JP2023-104360 A) describes that an NFT issuing system is provided which makes it possible to issue an NFT containing information related to the usage result of a device used by a user, while also allowing the user to easily grasp the content and approval status of the NFT.

The NFT issuing system described in Patent Literature 1 includes an NFT issuing unit, a display data processing unit, and an approval status monitoring unit.

The NFT issuing unit is connected to a user device used by a user and issues, on a blockchain, an NFT that includes information related to the usage result of the user device. The display data processing unit generates display data including information related to the usage result and provides the display data to the user device. The approval status monitoring unit monitors the approval status of the NFT on the blockchain. In addition, the display data processing unit includes information indicating the approval status in the display data.

In an online game or the like, there are users who, in a case where the level of a character or the like operated by the user reaches a predetermined value, wish to use the reached level as a “title” and present such a title in another online service such as a metaverse space. However, there does not exist any system that is capable of realizing such a desire.

It should be noted that Patent Literature 1 merely discloses a technique for issuing an NFT including information related to the usage result of a device used by a user. Accordingly, even if the technique disclosed in Patent Literature 1 is applied, the above-mentioned desire cannot be realized.

### SUMMARY

It is a main object of the present disclosure to provide a user information SBT-ing apparatus, a system, a control method of a user information SBT-ing apparatus, and a non-transitory computer-readable storage medium that contribute to enabling the use, on an online service, of titles or the like acquired by a user.

According to a first aspect of the present disclosure, there is provided a user information SBT-ing apparatus including: an issuing means that issues to a user as an owner, based on user information, the user information being information generated by a first server that provides a first service and related to a situation of the user who receives the first service, an SBT (SoulBound Token) corresponding to the user information; and a guaranteeing means that enables a second server, the second server providing a second service, to perform a display guaranteeing that the user owns the SBT.

According to a second aspect of the present disclosure, there is provided a system including: a first server that provides a first service; a second server that provides a second service; and a user information SBT-ing apparatus, and wherein the user information SBT-ing apparatus includes: an issuing means that issues to a user as an owner, based on user information, the user information being information generated by the first server and related to a situation of the user who receives the first service, an SBT (SoulBound Token) corresponding to the user information; and a guaranteeing means that enables the second server to perform a display guaranteeing that the user owns the SBT.

According to a third aspect of the present disclosure, there is provided a control method of a user information SBT-ing apparatus, the control method including: an issuing step that issues to a user as an owner, based on user information, the user information being information generated by a first server that provides a first service and related to a situation of the user who receives the first service, an SBT (SoulBound Token) corresponding to the user information; and a guaranteeing step that enables a second server, the second server providing a second service, to perform a display guaranteeing that the user owns the SBT.

According to a fourth aspect of the present disclosure, there is provided a non-transitory computer-readable storage medium storing a program causing a computer mounted on a user information SBT-ing apparatus to perform processing for: an issuing processing that issues to a user as an owner, based on user information, the user information being information generated by a first server that provides a first service and related to a situation of the user who receives the first service, an SBT (SoulBound Token) corresponding to the user information; and a guaranteeing processing that enables a second server, the second server providing a second service, to perform a display guaranteeing that the user owns the SBT.

### BRIEF DESCRIPTION OF THE DRAWINGS

Exemplary features and advantages of the present disclosure will become apparent from the following detailed description when taken with the accompanying drawings in which:

FIG. 1 is a diagram illustrating an outline of an example embodiment;

FIG. 2 is a flowchart illustrating an operation of an example embodiment;

FIG. 3 is a diagram illustrating an example of a schematic configuration of an information processing system according to an example embodiment of the present disclosure;

FIG. 4 is a diagram illustrating an operation of the information processing system according to the example embodiment of the present disclosure;

FIG. 5 is a diagram illustrating an operation of the information processing system according to the example embodiment of the present disclosure;

FIG. 6 is a diagram illustrating an example of a processing configuration of a service server according to the example embodiment of the present disclosure;

FIG. 7 is a diagram illustrating an example of a user management database according to the example embodiment of the present disclosure;

FIG. 8 is a diagram illustrating an example of a display of a terminal according to the example embodiment of the present disclosure;

FIG. 9 is a diagram illustrating an example of a display of the terminal according to the example embodiment of the present disclosure;

FIG. 10 is a diagram illustrating an example of a display of the terminal according to an example embodiment of the present disclosure;

FIG. 11 is a diagram illustrating an example of a processing configuration of a token management server according to the example embodiment of the present disclosure;

FIG. 12 is a flowchart illustrating an example of an operation of an SBT control unit according to the example embodiment of the present disclosure;

FIG. 13 is a diagram illustrating an example of a display of the terminal according to the example embodiment of the present disclosure;

FIG. 14 is a diagram illustrating an example of a display of the terminal according to the example embodiment of the present disclosure;

FIG. 15 is a diagram illustrating an example of a display of the terminal according to the example embodiment of the present disclosure;

FIG. 16 is a diagram illustrating an example of a display of the terminal according to the example embodiment of the present disclosure;

FIG. 17 is a diagram illustrating an example of a display of the terminal according to the example embodiment of the present disclosure;

FIG. 18 is a diagram illustrating an example of a display of the terminal according to the example embodiment of the present disclosure;

FIG. 19 is a sequence diagram illustrating an example of an operation of the information processing system according to the example embodiment of the present disclosure;

FIG. 20 is a diagram illustrating an example of a display of the terminal according to a variation of the example embodiment of the present disclosure; and

FIG. 21 is a diagram illustrating an example of a hardware configuration of a token management server according to the present disclosure.

### EXAMPLE EMBODIMENT

First, an outline of an example embodiment will be described. In the following outline, various components are denoted by reference characters for the sake of convenience. That is, the following reference characters are used as examples to facilitate the understanding of the present disclosure. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. It should be noted that, in the present description and drawings, elements that can be described in a like way will be denoted by a like reference character, and redundant description thereof will be omitted as needed.

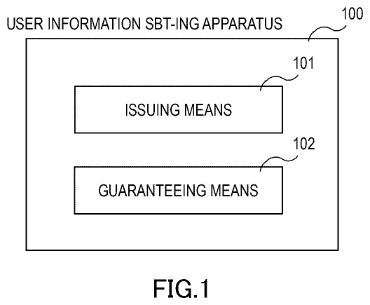

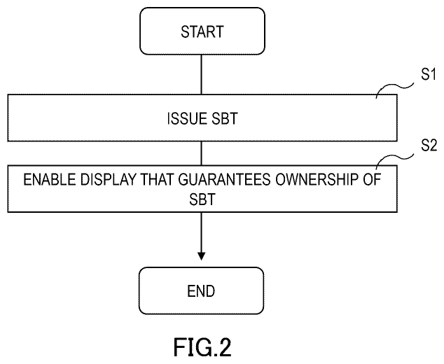

A user information SBT-ing apparatus 100 according to an example embodiment includes an issuing means 101 and a guaranteeing means 102 (see FIG. 1). The issuing means 101 that issues to a user as an owner, based on user information, the user information being information generated by a first server that provides a first service and related to a situation of the user who receives the first service, an SBT corresponding to the user information (step S1 in FIG. 2). The guaranteeing means 102 enables a second server, the second server providing a second service, to perform a display guaranteeing that the user owns the SBT (step S2).

The user information SBT-ing apparatus 100 issues an SBT based on user information generated as a result of a user receiving the provision of a first service. For example, the user information SBT-ing apparatus 100 issues an SBT corresponding to a title acquired by a user in an online game. In addition, the user information SBT-ing apparatus 100 enables a second server that provides a second service to perform a display guaranteeing that the user owns the SBT. For example, the user information SBT-ing apparatus 100 transmits the SBT issued to the user to the second server. The second server displays, in a manner recognizable to other users receiving the provision of the second service, the title acquired by the above user in the online game. That is, the user is able to use the acquired title or the like on an online service.

Hereinafter, specific example embodiments will be described in more detail with reference to drawings.

### First Example Embodiment

A first example embodiment will be described in more detail with reference to drawings.

An information processing system according to the first example embodiment issues an SBT (SoulBound Token) that certifies titles, qualifications, and the like acquired by a user in a virtual world or a real world. A user who has received the issuance of the SBT is able to present the title or the like in a virtual world. It should be noted that the SBT is a token configured so that resale is prohibited, and movement between wallets is not allowed.

For example, in a case where a user plays an online game and a level (the level of a main character in the game) reaches a predetermined value, an SBT that certifies that the predetermined level has been reached is issued. A user who has received the issuance of the SBT is able to present himself or herself in a metaverse space or the like as a player whose game level has reached the predetermined value. For example, a display such as “GameA: Lev10” is presented near an avatar of the user. By such a display, communication in the metaverse space is expected to become smoother and more active.

### Configuration of System

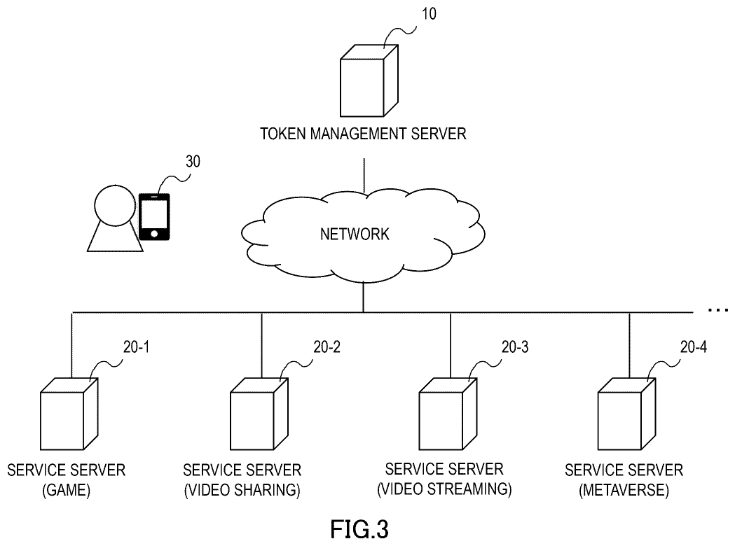

As shown in FIG. 3, an information processing system according to the first example embodiment includes a token management server 10 and a plurality of service servers 20-1 to 20-4.

In the following description, in a case where there is no particular reason to distinguish between the service servers 20-1 and 20-4, they will simply be referred to as “service server 20.”

A user possesses a terminal 30 such as a smartphone or an HMD (Head Mounted Display). The user operates the terminal 30 to access various servers or the like.

The token management server 10 is a server that is managed and operated by a business operator (token management platformer) that performs processes such as the issuance of tokens such as NFTs (Non-Fungible Tokens) and SBTs. The token management server 10 issues an SBT that certifies a title or the like acquired by a user. The token management server 10 performs management and the like of SBTs issued to users. The token management server 10 serves as a user information SBT-ing apparatus.

In addition, the token management server 10 realizes a so-called marketplace. The token management server 10 enables buying and selling of digital content (digital assets) that have been NFT-ized through the marketplace.

The service server 20 is a server that is managed and operated by a service business operator providing various online services to users.

For example, the service server 20-1 is a game server that provides an online game. The service server 20-1 performs control of the progress of the game. It should be noted that games targeted by the information processing system according to the first example embodiment include 3D games, FPS (First Person Shooter) games, action games, fighting games, RPGs (Role Playing Games), and the like.

For example, the service server 20-2 is a video sharing server that provides a video sharing service. The service server 20-2 provides a service in which individuals, companies, and the like can post videos, and users can view the posted videos. The service server 20-2 provides functions such as enabling viewers to leave comments on videos and enabling video uploaders and viewers to chat with each other.

For example, the service server 20-3 is a video streaming server that provides a video streaming service. The service server 20-3 performs streaming distribution of programs such as animation, dramas, and movies.

For example, the service server 20-4 is a metaverse server that provides a virtual space to users. The service server 20-4 is a virtual space control apparatus that performs control related to a virtual space. A user accesses the service server 20-4 by using an HMD or the like and performs activities in the metaverse space provided by the service server 20-4.

The online services provided by the service server 20 described above are illustrative examples. The service server 20 may provide an SNS (Social Networking Service) service, an EC (Electronic Commerce) service, and the like.

It should be noted that although not illustrated in FIG. 3, the information processing system includes a wallet server that provides a wallet service related to tokens such as NFTs and SBTs. A user is able to prove ownership of NFTs or SBTs by creating an account (wallet) in the wallet server.

Each apparatus shown in FIG. 3 is connected to a network. Specifically, the token management server 10, the service server 20, and the terminal 30 are connected to the network via wired or wireless communication means.

The configuration of the information processing system shown in FIG. 3 is an illustrative example, and is not intended to limit the configuration. For example, a plurality of token management servers 10 may be included in the system. Load distribution and redundancy may be realized by a plurality of token management servers 10.

### Schematic Operation

Next, a schematic operation of the information processing system according to the first example embodiment will be described.

### Account Generation

A user generates an account with each service business operator in order to enjoy services such as playing an online game, participating in a metaverse space, using a marketplace, and utilizing a wallet service.

Specifically, the user operates the terminal 30 to access the wallet server and generates an account (wallet). The user operates the terminal 30 to generate an account in a game server of a game that the user wishes to play. The user operates the terminal 30 to generate an account (an account for a marketplace) in the token management server 10.

### Account Linkage

A user sets, in the token management server 10, login information for logging into each of the service servers 20. For example, the user sets, in the token management server 10, login information (an ID and a password) for logging into the service server 20-1 (a game server) and the service server 20-4 (a metaverse server).

In addition, the user sets a wallet address (a wallet address generated by the wallet server) in the token management server 10 and in each of the service servers 20.

The token management server 10 associates and stores login information (an ID and a password) of a user, a wallet address, and login information corresponding to each of the service servers 20. Each service server 20 associates and stores its own service login information and the wallet address or the like.

### Accumulation of User Information

The service server 20, in a case where a service is provided to a user, stores information related to the user (particularly, information related to a status of the user) as user information. The service server 20 stores the user information in an account of the user who has logged in. The user information stored by the service server 20 differs depending on the service provided to the user.

For example, the service server 20-1 that provides an online game stores, as user information, information such as items acquired by the user during the game, levels reached, and events achieved. The service server 20-1 stores a play history of the game.

Alternatively, the service server 20-2 that provides a video sharing service stores, as user information, comments left by a user, amounts of donations (monetary tips), purchased merchandise, and the like, classified according to the agency to which the streamer belongs or according to each streamer. For example, the service server 20-2 stores, in the account of the user, the amount of a monetary tip made by the user to a streamer (including a virtual streamer who performs streaming using an avatar) and the fact that the user has purchased goods of the streamer (including the purchased items and amounts). Alternatively, the service server 20-2 stores, as user information, points acquired by the user by making payments to a streamer.

Alternatively, the service server 20-3 that provides a video streaming service stores, as user information, information about programs viewed by the user (for example, program titles, viewing times, and the like). For example, in a case where a user has viewed up to the tenth episode of an animation program A that consists of twenty episodes, the service server 20-3 stores, as user information in the user's account, information such as “Animation Program A: Ten Episodes Viewed.”

Alternatively, the service server 20-4 that provides a metaverse space stores, as user information, actions of a user in the metaverse space. For example, in a case where a user hosts an event in the metaverse space, the service server 20-4 stores, as user information in the user's account, the fact that the event has been held.

### Issuance of SBT

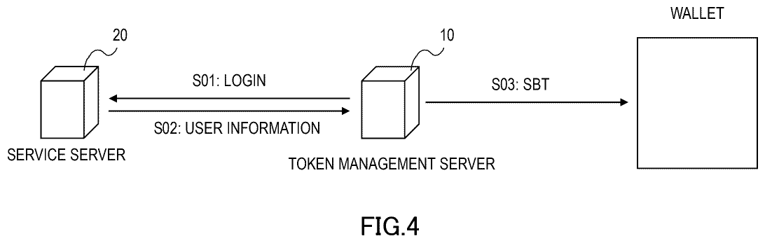

As described above, the token management server 10 stores login information for the online services used by a user. The token management server 10 periodically or at a predetermined timing accesses the service server 20 and logs into the user's account by using the stored login information (step S01 in FIG. 4).

The token management server 10 acquires user information stored in the logged-in account (step S02).

The token management server 10 determines, by using the acquired user information, whether or not a “title” can be granted to the user. For example, the token management server 10 refers to table information in which titles prepared for each online service and conditions for acquiring those titles are stored, and determines whether or not the granting of the title is possible.

For example, in relation to an online game A, in a case where a user acquires a rare item B, the token management server 10 determines that it is possible to grant to the user a title such as “Game A: Item B Acquired.”

Alternatively, in relation to a video sharing service, in a case where the amount of a monetary tip given by a user to a streamer A is equal to or greater than a predetermined amount, the token management server 10 determines that it is possible to grant to the user a title such as “Streamer A: 10,000 Yen Tip.”

Alternatively, in relation to a video streaming service, in a case where a user views all episodes of an animation program A, the token management server 10 determines that it is possible to grant to the user a title such as “Animation Program A: All Episodes Viewed.”

Alternatively, in relation to a metaverse space A, in a case where a user holds an event B in which ramen enthusiasts gather, the token management server 10 determines that it is possible to grant to the user a title such as “Metaverse Space A: Ramen Event B Hosted.”

In a case where it is determined, based on the user information, that a title can be granted to the user, the token management server 10 acquires whether or not the user desires the issuance of an SBT corresponding to the grantable title. That is, the token management server 10 acquires whether or not the user desires to present the acquired title online.

For example, in a case where a user logged into a marketplace performs a predetermined operation (for example, pressing a title acquisition button), the token management server 10 determines whether or not the title can be granted, and if a grantable title exists, acquires whether or not the user desires the issuance of the SBT corresponding to the title. Alternatively, the token management server 10 determines, at the timing of the user logging into the account, whether or not the title can be granted, and if a grantable title exists, acquires whether or not the user desires the issuance of the SBT corresponding to the title.

In a case where the user desires the issuance of the SBT, the token management server 10 issues an SBT for the title that the user desires to use online (step S03).

In this case, a person in charge of the token management platform or the like generates a smart contract for issuing an SBT corresponding to the title acquired by the user and deploys the generated smart contract on the blockchain.

The token management server 10, in a case where the issuance of the SBT becomes necessary, calls a function of the smart contract and inputs information necessary for the issuance of the SBT (such as the wallet address, information related to the acquired title, and the ID of the token management platformer).

By executing the smart contract, the wallet (wallet address) of the user is associated with the SBT related to the title acquired by the user. An SBT corresponding to the acquired title is issued to the user.

A user is able to check the SBT owned by the user in an account of the token management server 10. The user is able to check the SBTs and NFTs owned by the user by logging into the account of the token management server 10.

### Use of Title

A user who has received the issuance of an SBT corresponding to an acquired title is able to present the acquired title in an online service. For example, the user is able to present a title acquired through playing an online game in a metaverse space. For example, a user who has acquired a title such as “Game A: Item B Acquired” is able to express the fact in the metaverse space.

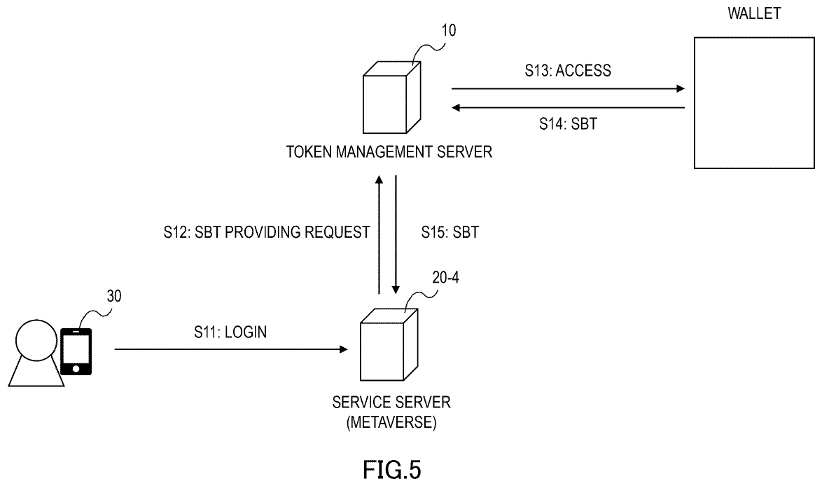

For example, in a metaverse space, a user who attempts to present a title of an online game logs into the metaverse server (the service server 20-4) (step S11 in FIG. 5). The user gives an instruction to the logged-in service server 20-4 to acquire the SBT. In response to the instruction, the service server 20-4 transmits to the token management server 10 an SBT providing request including the wallet address of the user (step S12).

The token management server 10 accesses the wallet of the user by using the wallet address included in the SBT providing request and acquires each SBT owned by the user (steps S13 and S14).

The token management server 10 transmits at least one or more of the acquired SBTs to the service server 20-4 (step S15). Specifically, the token management server 10 transmits to the service server 20-4 a positive response (a response to the SBT providing request) including at least one or more SBTs.

After acquiring the SBT, the service server 20-4 displays on the terminal 30 a list of information related to the acquired SBTs, thereby allowing the user to select a title. For example, the service server 20-4 displays, on the terminal 30, a list of the SBTs owned by the user.

Thereafter, the service server 20-4 uses the title selected by the user in the metaverse space in a form recognizable by other users. For example, the service server 20-4 displays the acquired title near the avatar of the user.

Next, details of the individual apparatuses included in the information processing system according to the first example embodiment will be described.

### Service Server

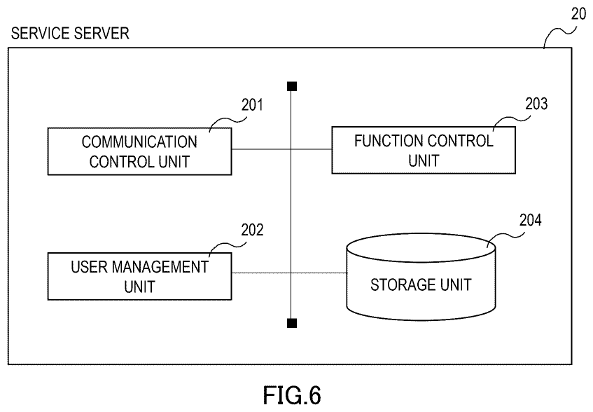

FIG. 6 is a diagram illustrating an example of a processing configuration (processing modules) of the service server 20 according to an example embodiment of the present disclosure. Referring to FIG. 6, the service server 20 includes a communication control unit 201, a user management unit 202, a function control unit 203, and a storage unit 204.

The communication control unit 201 is means for controlling communication with other apparatuses. For example, the communication control unit 201 receives data (packets) from the terminal 30. In addition, the communication control unit 201 transmits data to the terminal 30. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

The user management unit 202 is means for performing control and management related to users.

The user management unit 202 acquires information such as a name, a gender, a date of birth, and login information (an ID, a password) from a user who has accessed a predetermined website (for example, a user registration site). In addition, the user management unit 202 acquires a wallet address of the user.

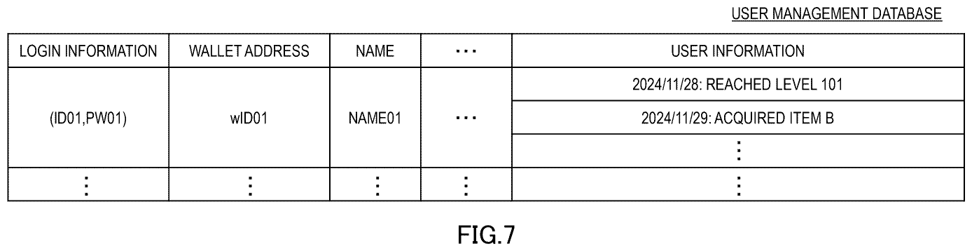

The user management unit 202 stores the acquired name, login information, wallet address, and the like in a user management database (see FIG. 7). The user management unit 202 associates and stores the user's name, wallet address, login information, and the like with user information in each user's account. It should be noted that the user management database shown in FIG. 7 is an example, and is not intended to limit the items or contents to be stored. For example, biometric information of the user (for example, a face image) may be stored in the user management database.

The user management unit 202 authenticates a user who has accessed a predetermined website or the like to receive a service. The user management unit 202 authenticates the user by using the login information.

The function control unit 203 is means for performing control related to functions assigned to each service server 20.

The function control unit 203 stores, in the account of the user, user information generated by providing a service to the user.

In addition, the function control unit 203 acquires an SBT owned by the user in accordance with an instruction or the like from the user. For example, in a case where the function control unit 203 detects a predetermined operation performed by the user (for example, pressing of an SBT acquisition button), the function control unit 203 transmits to the token management server 10 an SBT providing request including the wallet address of the user.

The function control unit 203 receives, from the token management server 10, a response to the SBT providing request.

In a case where a negative response indicating that SBT provision is impossible is received, the function control unit 203 notifies the user that there is no SBT available for acquisition or that the acquisition of the SBT has failed.

In a case where a positive response indicating that SBT provision is possible is received, the function control unit 203 acquires, from among at least one or more SBTs included in the positive response, an SBT that the user desires to use (for presentation of a title) in an online service.

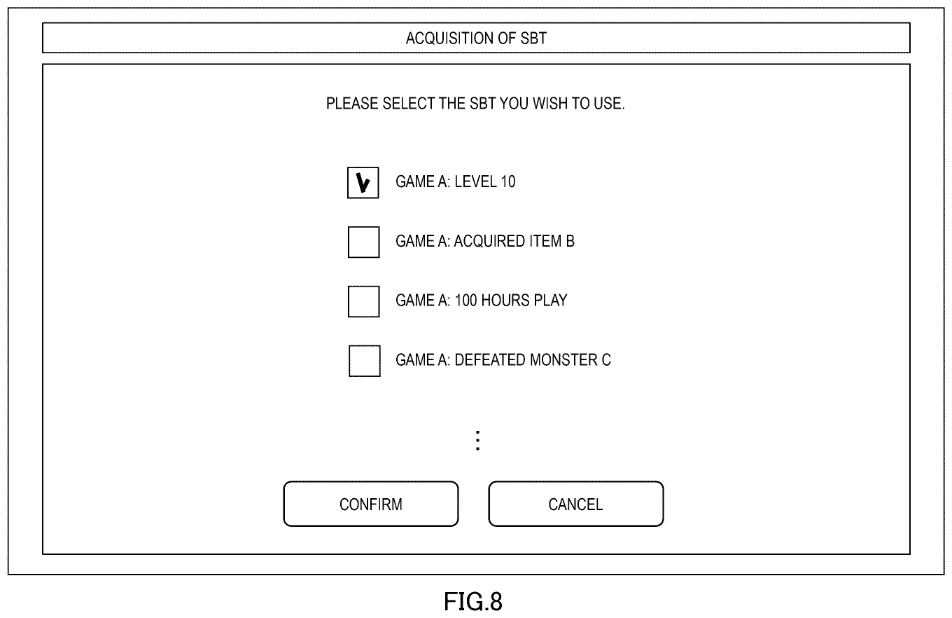

For example, the function control unit 203 specifies the SBT that the user desires to use by using a GUI as shown in FIG. 8. It should be noted that, as shown in FIG. 8, the function control unit 203 may specify the SBT that the user desires to use while displaying information obtained from each acquired SBT (for example, the name of the title acquired by the user).

The function control unit 203 uses the specified SBT (the title guaranteed by the SBT) in the online service.

For example, the function control unit 203 of a game server (the service server 20-1) displays the title acquired by the user near the player operated by the user. Alternatively, a video sharing server (the service server 20-2) or a video streaming server (the service server 20-3) displays the acquired title in its own account.

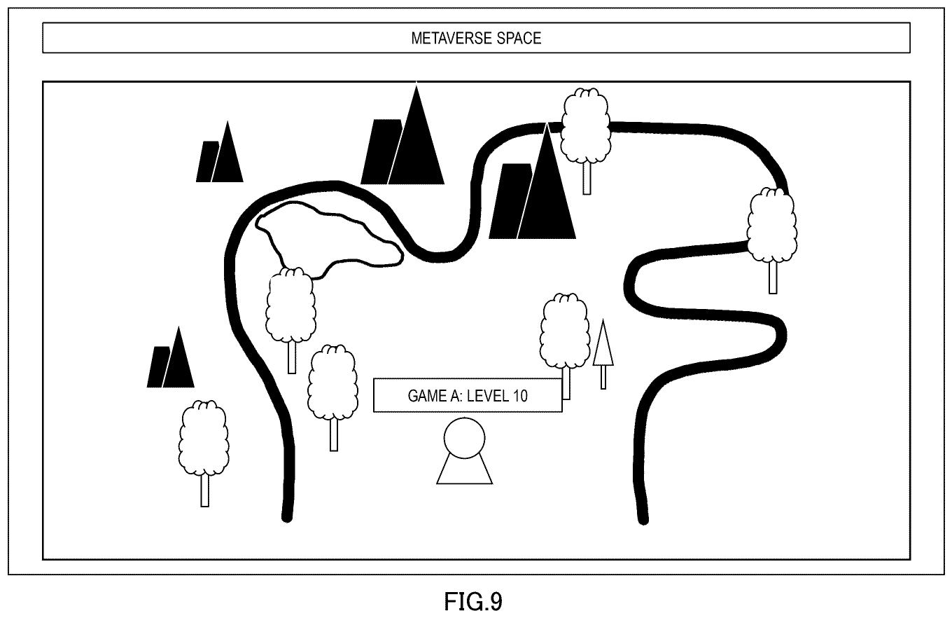

Alternatively, a metaverse server (the service server 20-4) displays the title near the avatar of the user. For example, the function control unit 203 displays, near the avatar of the user as shown in FIG. 9, the title corresponding to the SBT selected by the user. Another user who encounters the displayed title is able to start a conversation related to the game A with the user (the user presenting the title).

In addition, the function control unit 203 realizes unique functions assigned to each of the service servers 20.

Hereinafter, representative functions realized by the service servers 20-1 to 20-4 corresponding respectively to a game server, a video sharing server, a video streaming server, and a metaverse server will be described.

### Game Server

The function control unit 203 of the service server 20-1 controls the progress of an online game. The function control unit 203 stores, as user information in the account, information such as levels reached by the user and items acquired in association with the progress of the game.

### Video Sharing Server

The function control unit 203 of the service server 20-2 provides a video sharing service. The function control unit 203 stores, as user information in the account, information such as comments made by the user to a streamer and amounts of monetary tips given. In addition, in a case where the user purchases merchandise of the streamer, the function control unit 203 stores the fact as user information in the account.

In addition, the function control unit 203 may grant points for actions performed by the user toward the streamer (particularly, monetary contributions). For example, the function control unit 203 may grant to the user “support points” corresponding to the amount of a monetary tip or to purchased merchandise. Alternatively, the function control unit 203 may grant support points to the user in cases where the user purchases NFTs of the streamer (such as illustrations of the streamer), invites friends, or answers questionnaires.

At that time, the function control unit 203 may assign a weight to each action of the user. For example, the function control unit 203 may assign the largest weight to the purchase of NFTs.

The number of the support points may be stored in the account as user information. It should be noted that the support points are aggregated and accumulated for each streamer and for each predetermined period (season).

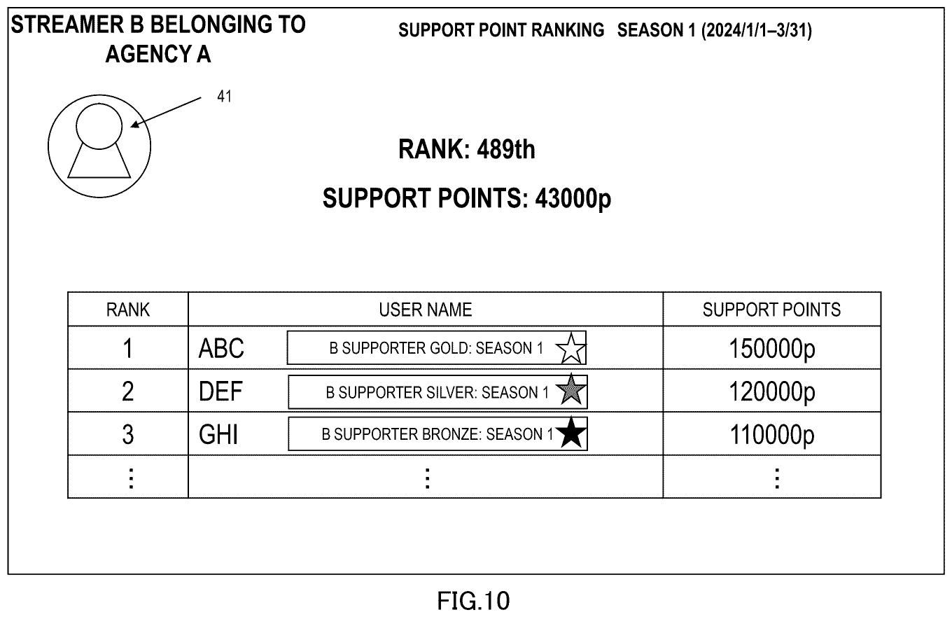

The function control unit 203 may display, for each streamer, the support points acquired by each user in a ranking format or the like. For example, in a case where a user performs a predetermined operation (for example, pressing of a support ranking display button) on a streamer's page, the function control unit 203 displays, on the terminal 30, a screen such as that shown in FIG. 10.

As shown in FIG. 10, the function control unit 203 displays a photo or avatar of the streamer in an icon display area 41. In addition, the function control unit 203 displays the number of support points acquired by each user and a ranking according to the support points.

In addition, for users with a high number of support points, the function control unit 203 displays the user name and the number of support points acquired. At that time, the function control unit 203 may display the title acquired by the user near the user name. In FIG. 10, the display such as “B Supporter Gold: Season 1” shown next to the user name corresponds to the title of the user.

### Video Streaming Server

The function control unit 203 of the service server 20-3 performs streaming distribution of a program selected by the user. The function control unit 203 stores, as user information, information about the programs viewed by the user (for example, program titles, viewing times, and the like).

### Metaverse Server

The function control unit 203 of the service server 20-4 enables actions of the user in the metaverse space. The function control unit 203 stores, as user information, predetermined actions of the user in the metaverse space.

Here, the function control unit 203 may express the title acquired by the user in another form instead of, or in addition to, displaying the title near the avatar. For example, the function control unit 203 may display an accessory corresponding to the title (an accessory worn by the avatar) or may display the title in the form of a status indicator.

Alternatively, the function control unit 203 may display that the title or the like acquired by the user is officially certified by a service business operator or an IP (Intellectual Property) holder. The function control unit 203 may display, in a format recognizable by others, that the title acquired by the user is officially certified. For example, the function control unit 203 may display an irregular accessory (a forged or imitation accessory) and an official accessory in a distinguishable manner.

The storage unit 204 is means for storing information necessary for the operation of the service server 20.

### Token Management Server

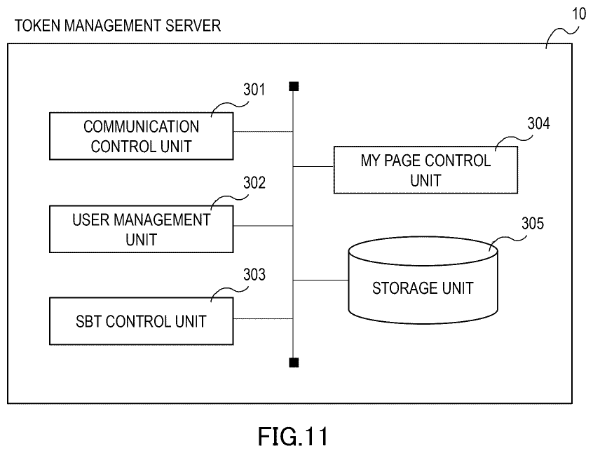

FIG. 11 is a diagram illustrating an example of a processing configuration (processing modules) of the token management server 10 according to the example embodiment disclosed in the present application. Referring to FIG. 11, the token management server 10 includes a communication control unit 301, a user management unit 302, an SBT control unit 303, a my page control unit 304, and a storage unit 305.

The communication control unit 301 is means for controlling communication with other apparatuses. For example, the communication control unit 301 receives data (packets) from the terminal 30. In addition, the communication control unit 301 transmits data to the terminal 30. The communication control unit 301 gives data received from other apparatuses to other processing modules. The communication control unit 301 transmits data acquired from other processing modules to other apparatuses. In this way, other processing modules transmit and receive data to and from other apparatuses via the communication control unit 301. The communication control unit 301 includes a function as a receiving unit that receives data from other apparatuses and a function as a transmitting unit that transmits data to other apparatuses.

The user management unit 302 is means for performing control and management related to users.

The user management unit 302 acquires information such as a name, a gender, a date of birth, and login information (ID, password) from a user who has accessed a predetermined website (for example, a user registration site). In addition, the user management unit 302 acquires the wallet address of the user and the login information for logging into each service server 20 on which the user has created an account.

The user management unit 302 stores the acquired name, login information, wallet address, and login information for each service server 20 in a predetermined database. The user management unit 302 uses a database similar to the user management database shown in FIG. 7 to store the login information and the like.

The SBT control unit 303 is means for performing control related to an SBT granted to a user.

The SBT control unit 303 includes both a function as issuing means and a function as guaranteeing means.

The issuing means issues, as an owner, an SBT corresponding to user information based on the user information related to the status of a user who receives a first service, the user information being information generated by a first server that provides the first service. The guaranteeing means enables a second server that provides a second service to perform a display guaranteeing that the user owns the SBT. More specifically, the guaranteeing means transmits the SBT owned by the user to the second server in response to a request from the second server.

It should be noted that the first server is, for example, a game server or a video sharing server. The second server is, for example, a metaverse server. However, the first and second servers are not limited to these examples. It should be noted that the SBT issued by the guaranteeing means proves that the user owns a title or the like acquired by receiving the first service.

In addition, by transmitting the SBT owned by the user to the second server, the second server is able to perform a display the guarantee that the SBT is officially recognized by the service provider that provides the first service.

The first service provided by the first server includes at least one of an online game service, a video sharing service, a video streaming service, and a metaverse service. The second service provided by the second server includes a metaverse service.

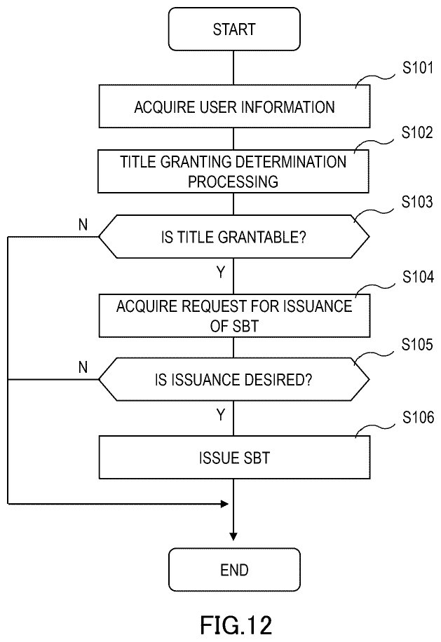

FIG. 12 is a flowchart illustrating an example of the operation of the SBT control unit 303 according to the example embodiment disclosed in the present application. The operation of the SBT control unit 303 will be described with reference to FIG. 12.

The SBT control unit 303 acquires user information of the user (step S101). For example, the SBT control unit 303 acquires the latest user information stored in the account of the online service used by the user.

Specifically, the SBT control unit 303 accesses the service server 20 in which login information is registered in the user's account at regular intervals or at predetermined timing. For example, the SBT control unit 303 accesses the service server 20 at the timing at which the user logs into the account (an account of the token management server 10). Alternatively, the SBT control unit 303 may access the service server 20 in response to an instruction from the user who has logged into the account.

For example, in a case where accounts of a game server and a video sharing server are stored in the user's account, the SBT control unit 303 accesses each of these servers (the service server 20-1 and the service server 20-2). The SBT control unit 303 logs into the game server or the like using the login information corresponding to the game server or the like.

The SBT control unit 303 acquires user information from the account of the service server 20 into which it has logged.

For example, the SBT control unit 303 acquires the user's game play history from the service server 20-1 that provides an online game. For example, the SBT control unit 303 acquires, as user information, information (play history) such as items obtained, levels reached, and events achieved by the user during the game.

Similarly, the SBT control unit 303 acquires user information from a video sharing server, a video streaming server, a metaverse server, and the like.

After acquiring the user information, the SBT control unit 303 determines whether or not a specific title can be granted to the user (title granting determination processing; step S102).

For example, the SBT control unit 303 refers to table information storing titles prepared for each online service and conditions for obtaining the titles, and determines whether or not the titles can be granted.

In a case where the title cannot be granted to the user (step S103, No branch), the SBT control unit 303 terminates the processing.

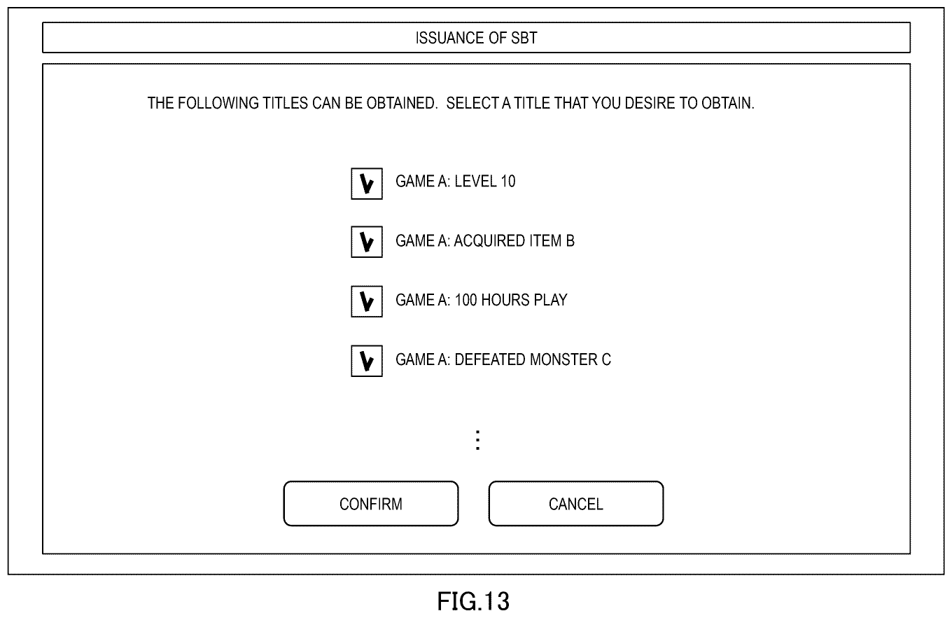

In a case where the title can be granted to the user (step S103, Yes branch), the SBT control unit 303 acquires whether or not the user desires the issuance of an SBT corresponding to the grantable title (step S104). For example, the SBT control unit 303 acquires whether or not the user desires the issuance of the SBT by displaying, on the terminal 30, a GUI (Graphical User Interface) as shown in FIG. 13.

In a case where the user does not desire the issuance of the SBT (step S105, No branch), the SBT control unit 303 terminates the processing.

In a case where the user desires the issuance of the SBT (step S105, Yes branch), the SBT control unit 303 issues an SBT corresponding to the title that the user desires to use online (step S106).

Specifically, the SBT control unit 303 calls a function of a smart contract deployed on a node on the blockchain and issues an SBT corresponding to the title obtained by the user.

For example, the SBT control unit 303 inputs, into the smart contract, the wallet address as the address of the person to whom the SBT is issued, and the wallet address of the token management platformer as the ID of the issuer of the SBT. In addition, the SBT control unit 303 inputs, into the smart contract, information related to the title obtained by the user, such as the name of the online service and the detailed content of the title. Alternatively, in a case where the SBT related to a video sharing service is to be issued, the SBT control unit 303 inputs, into the smart contract, information such as a streamer and an agency to which the streamer belongs.

The smart contract, using this information, issues an SBT that designates the title holder as the owner and the token management platformer as the issuer, the SBT including, in its metadata, information related to the title granted to the user.

The SBT control unit 303 repeats the processing shown in FIG. 12 for each service provider (service server 20) associated with the account.

It should be noted that the issuance of an SBT using a smart contract is not the purpose of the present disclosure, and thus a more detailed description thereof will be omitted.

In addition, the SBT control unit 303 processes an SBT providing request received from the service server 20. Upon receiving the SBT providing request, the SBT control unit 303 accesses the user's wallet using the wallet address included in the request and acquires each SBT owned by the user.

In a case where at least one or more SBTs are acquired, the SBT control unit 303 transmits a positive response indicating that the SBT provision is available to the service server 20. At that time, the SBT control unit 303 transmits, to the service server 20, a positive response including the at least one or more acquired SBTs.

In a case where at least one or more SBTs cannot be acquired, the SBT control unit 303 transmits a negative response indicating that the SBT provision is unavailable to the service server 20.

The my page control unit 304 is a means for performing control related to an account (a my page) of a user. The my page control unit 304 includes a function for displaying information related to NFTs and SBTs owned by the user. The my page control unit 304 includes a function as display means for displaying at least one or more SBTs owned by the user.

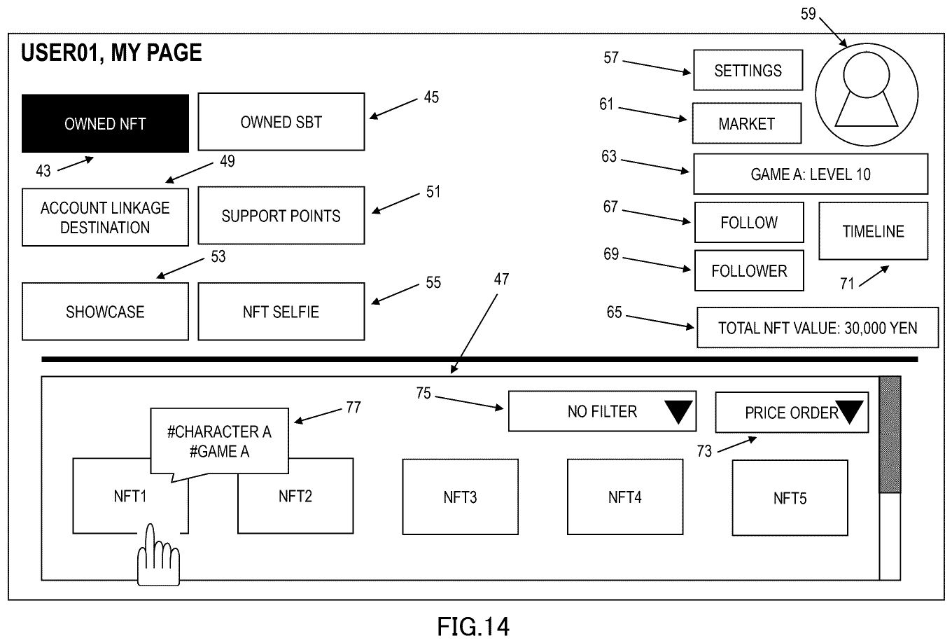

The my page control unit 304 displays, on the terminal 30, a my page such as that shown in FIG. 14 in a case where the user logs into the marketplace.

As shown in FIG. 14, the my page control unit 304 displays an owned NFT button 43 and an owned SBT button 45 on the my page.

The my page control unit 304 displays, in a list display area 47, a list of NFTs owned by the user in a case where the owned NFT button 43 is pressed (activated). Similarly, in a case where the owned SBT button 45 is pressed, the my page control unit 304 displays, in the list display area 47, a list of SBTs owned by the user.

It should be noted that an example of the display of the my page in a case where the owned SBT button 45 is pressed will be described below.

In order to enable list display of NFTs and SBTs, the my page control unit 304 accesses the wallet of the user and acquires the NFTs and SBTs owned by the user. It should be noted that the timing at which the my page control unit 304 acquires the NFTs and SBTs may be the timing at which the user logs in or the timing at which the owned NFT button 43 or the owned SBT button 45 is pressed.

In a case where an account linkage destination button 49 shown in FIG. 14 is pressed, the my page control unit 304 displays a list of service providers (online services) with which the user has linked accounts. For example, in a case where the user has registered accounts of a game server, a video sharing server, and a metaverse server in the marketplace, the my page control unit 304 displays, in a list format, service names or the like corresponding to these servers.

In addition to the owned NFT button 43 and the like, the my page control unit 304 may display, on the my page, a support point button 51, a showcase button 53, an NFT selfie button 55, and the like. The operation of the my page control unit 304 in a case where these buttons are pressed will be described below.

In a case where a setting button 57 shown in FIG. 14 is pressed, the my page control unit 304 enables various settings related to the my page and registration of login information for account linkage destinations.

In addition, the my page control unit 304 displays an icon of the user in an icon display area 59 of the my page. The my page control unit 304 may change an icon displayed in the icon display area 59 or the like in accordance with a setting change. For example, the my page control unit 304 may display, as the icon in the icon display area 59, an image (digital art) corresponding to an NFT owned by the user.

The my page control unit 304 may display, on the my page, a market button 61 for participating in the marketplace.

The my page control unit 304 may display, on the my page, a title acquired by the user (a title for which an SBT has been issued). For example, the my page control unit 304 may display, in a title display area 63 as shown in FIG. 14, a title for which the SBT has been issued. The title displayed in the title display area 63 may be selectable by the user on a setting page or the like that appears upon pressing the setting button 57.

Alternatively, the my page control unit 304 may calculate the total transaction amount of NFTs owned by the user (for example, the amount paid by the user when purchasing the NFTs) and display it on the my page. For example, as shown in FIG. 14, the my page control unit 304 may display, in an NFT total amount display field 65, the total amount calculated as described above.

The my page control unit 304 may display, on the my page, buttons corresponding to functions related to a social networking service (SNS).

For example, the my page control unit 304 may display, on the my page, a follow button 67 for displaying a list of other users followed by the user. Alternatively, the my page control unit 304 may display, on the my page, a follower button 69 for displaying in a list other users (followers) who follow the user. Alternatively, the my page control unit 304 may display, on the my page, a timeline button 71 for displaying a timeline.

It should be noted that, in a case where account information of an SNS server that provides an SNS service is registered in the token management server 10, the my page control unit 304 may display, on the my page, function buttons related to the SNS. In addition, the my page control unit 304 may log into the user's SNS account using the login information of the SNS server and acquire user information (such as IDs of followers and the like) from the account.

The my page control unit 304 may provide an interface for sorting the NFTs and SBTs displayed in the list display area 47 or for setting display and non-display thereof.

For example, the my page control unit 304 may sort the NFTs and SBTs owned by the user in accordance with the setting value of a sorting box 73 displayed in the list display area 47. For example, the my page control unit 304 may perform sorting in accordance with settings such as the acquisition price order of NFTs, the name order of NFTs and SBTs, or the acquisition date and time order of NFTs and SBTs.

Alternatively, the my page control unit 304 may switch between display and non-display of NFTs and SBTs owned by the user in accordance with the setting value of a filter box 75 for selecting (filtering) NFTs and SBTs to be displayed in the list display area 47.

The my page control unit 304 may display tags set for NFTs and SBTs. For example, the my page control unit 304 may display tags (hashtags) for NFTs listed on the my page (NFTs displayed in the list display area 47).

The tag may be assignable by a user. Alternatively, the my page control unit 304 may extract (calculate) a tag from information described in metadata of the NFT or the like.

For example, as shown in FIG. 14, in a case where the my page control unit 304 detects a predetermined operation by a user with respect to an NFT (for example, clicking the NFT or moving a mouse) in the my page, the my page control unit 304 displays a tag of the NFT in a popup 77. Alternatively, the tag of the NFT may be displayed under the corresponding NFT.

Subsequently, the operation of the my page control unit 304 in a case where the owned SBT button 45 is pressed will be described.

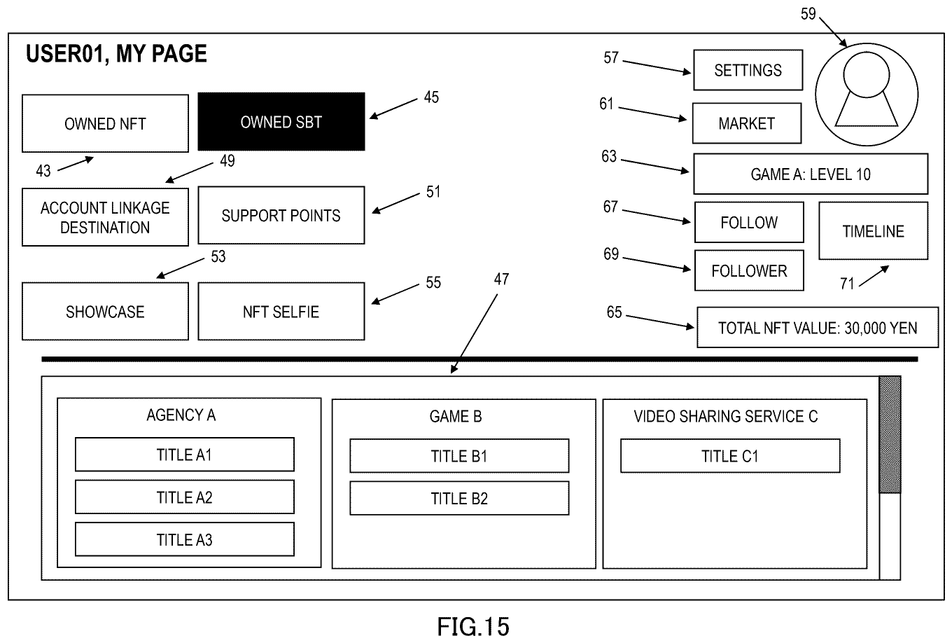

In a case where the owned SBT button 45 is pressed, the my page control unit 304 displays, in the list display area 47, a list of SBTs owned by the user (a list of titles guaranteed by the SBTs) (see FIG. 15).

At that time, as shown in FIG. 15, the my page control unit 304 may display, in list format, the SBTs (titles) classified according to the information on which the issuance of each SBT is based.

For example, the my page control unit 304 may display the SBTs (titles) for each agency to which the streamers, to whom the user made payment actions in a video sharing service, belong. For example, FIG. 15 shows titles A1 to A3 acquired by the user through making payment actions for a streamer B who belongs to an agency A. For example, the title A1 is a title such as “Top 500 Supporter of Streamer B, Season 1.” The title A2 is a title such as “Participant of the 3rd Anniversary Live of Streamer B.” The title A3 is a title such as “Purchaser of Streamer B's 3rd Anniversary Live Goods.”

Alternatively, the my page control unit 304 may display the SBTs for each game played by the user. For example, FIG. 15 shows titles B1 and B2 acquired by the user through playing a game B. For example, the title B1 is a title such as “SS Rank Achiever.” The title B2 is a title such as “150-Day Login.”

Alternatively, the my page control unit 304 may display SBTs for each video streaming service used by the user. For example, FIG. 15 shows a title C1 acquired by the user through viewing a program on a streaming service C. For example, the title C1 is a title such as “Complete Viewing of All Episodes of Anime Program C, Season 1.”

Subsequently, the operation of the my page control unit 304 in a case where the support point button 51, the showcase button 53, or the NFT selfie button 55 is pressed will be described.

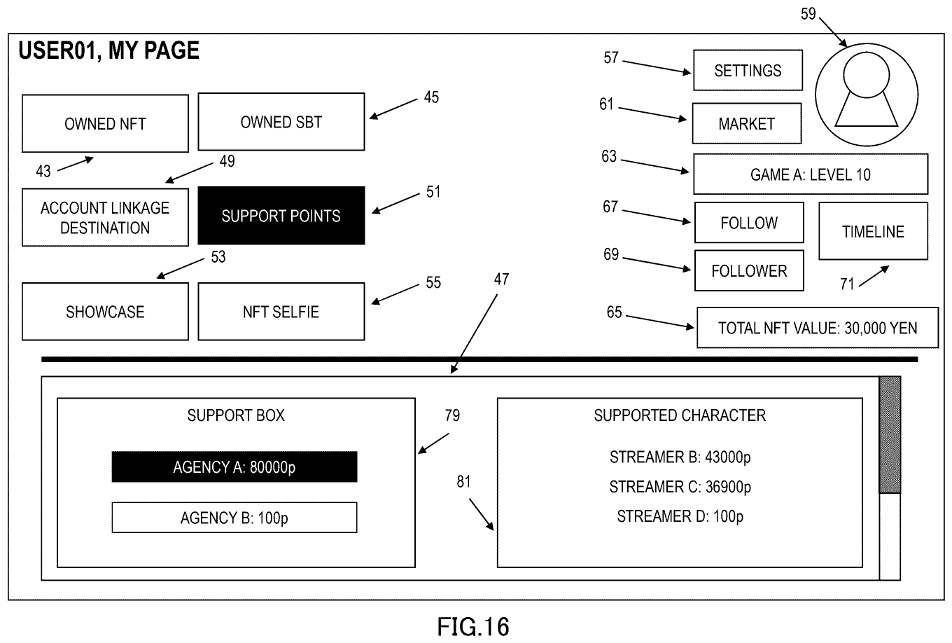

In a case where the support point button 51 is pressed, the my page control unit 304 displays information related to the support points acquired by the user in a video sharing service (see FIG. 16). At that time, the my page control unit 304 may display the support points for each agency and each streamer. In the example of FIG. 16, the agency and the streamer are displayed as “support box” and “supported character,” respectively.

The my page control unit 304 displays, in a support box field 79, the total number of support points for streamers belonging to each agency. In a case where the user selects an agency displayed in the support box field 79, the my page control unit 304 displays, in a supported character field 81, the support points (the breakdown of the total number of support points) for each streamer belonging to the selected agency.

In the example of FIG. 16, an agency A is selected by the user, and the support points acquired by the user for each of the streamers B to D belonging to the agency A are displayed.

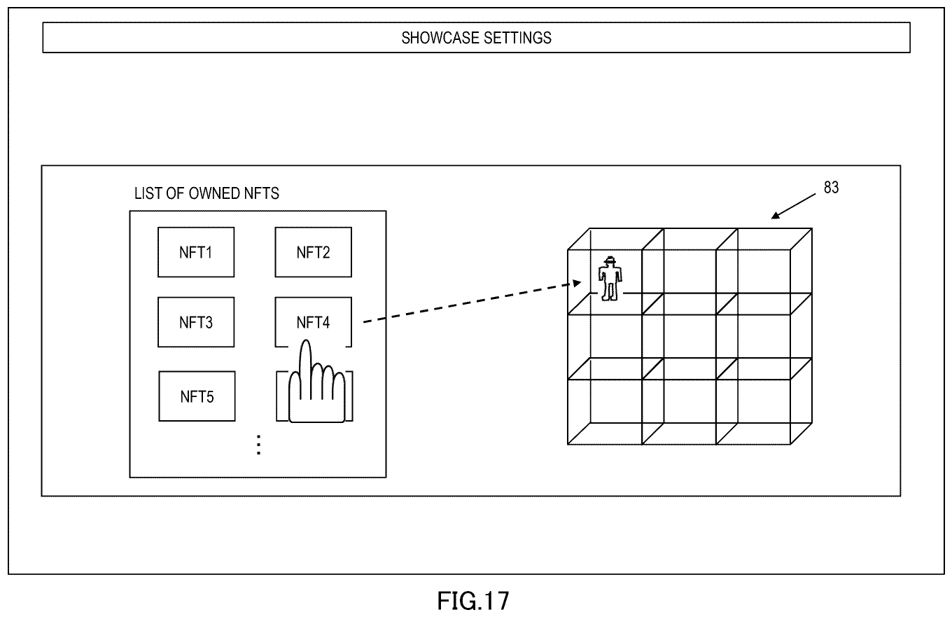

In a case where the showcase button 53 is pressed, the my page control unit 304 enables a configuration in which the content corresponding to NFTs owned by the user (for example, image data or 3D models of characters) is arranged in a pseudo showcase. For example, in a case where the showcase button 53 is pressed, the my page control unit 304 provides an interface as shown in FIG. 17.

In FIG. 17, a list of NFTs (content corresponding to the NFTs) owned by the user and a pseudo showcase 83 are displayed. In FIG. 17, in a case where the user selects one NFT from among the displayed NFTs and drags and drops it onto an arbitrary cuboid of the pseudo showcase 83, the content corresponding to the selected NFT is arranged in the cuboid where it was dropped. In the example of FIG. 17, a character corresponding to NFT4 is arranged in the upper left cuboid of the pseudo showcase 83.

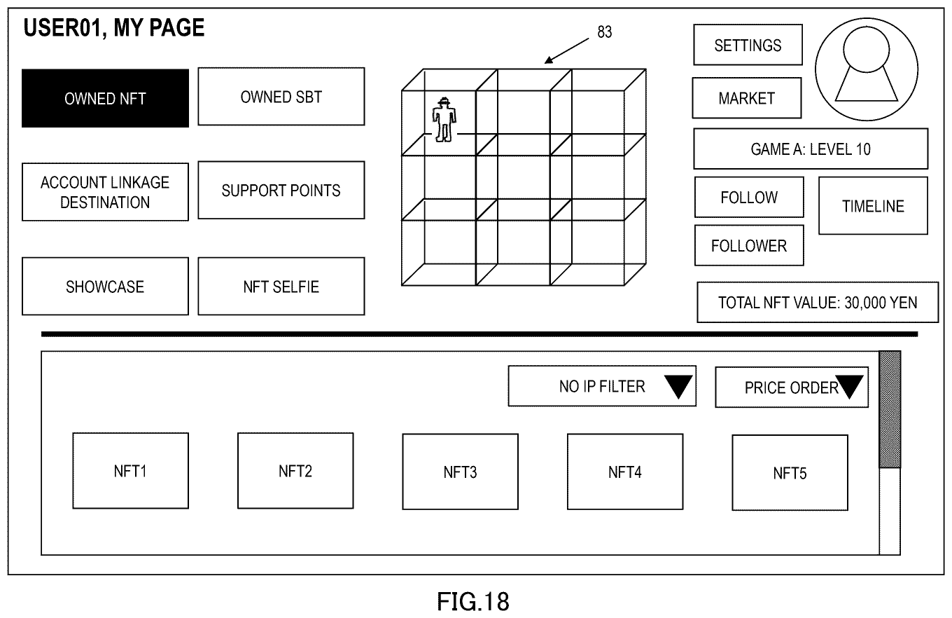

The pseudo showcase 83, in which digital content (a character) has been arranged, may be displayed on the my page (see FIG. 18).

In a case where the NFT selfie button 55 is pressed, the my page control unit 304 enables the superimposition of NFTs (content corresponding to the NFTs) owned by the user onto a selfie image of the user. The my page control unit 304 superimposes digital content (digital art) corresponding to the NFT selected by the user onto the user's selfie image, thereby generating image data in which the user and the digital content (for example, a character) appear to be together.

The storage unit 305 is means for storing information necessary for the operation of the token management server 10.

It should be noted that the token management server 10 provides a marketplace for buying and selling NFTs of digital content (digital assets) among users. The description of processing modules related to the marketplace will be omitted.

### Terminal

Examples of the terminal 30 include a portable terminal device such as smartphones, HMDs, mobile phones, game machines, and tablets, and also computers (personal computers and notebook computers). The terminal 30 can be any apparatus or device insofar as it accepts user operations and is capable of communicating with the token management server 10 or the like. In addition, since the configuration or the like of the terminal 30 is apparent to those skilled in the art, a detailed description thereof will be omitted.

### Operation of System

Next, operations of the information processing system according to the first example embodiment will be described.

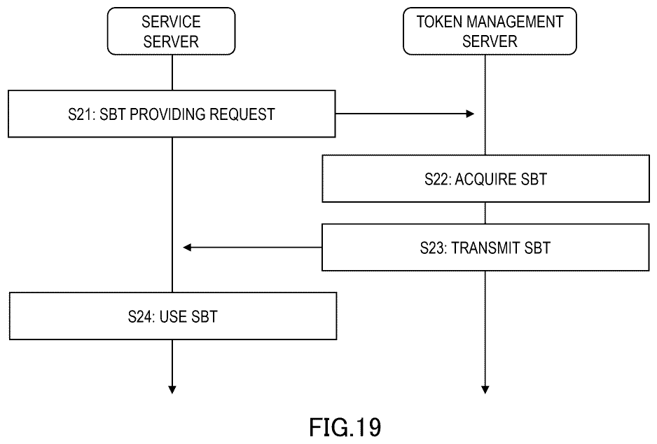

FIG. 19 is a sequence diagram illustrating an example of the operations of the information processing system according to the example embodiment disclosed in the present application. With reference to FIG. 19, the operations of the information processing system according to the first example embodiment will be described.

The service server 20 transmits an SBT providing request to the token management server 10 in response to an instruction or the like from the user (step S21).

The token management server 10 accesses the user's wallet and acquires the SBT (step S22).

The token management server 10 transmits the acquired SBT to the service server 20 (step S23).

The service server 20 uses the acquired SBT in the online service (step S24). For example, the metaverse server displays the title corresponding to the acquired SBT together with the user's avatar.

Next, variations according to the first example embodiment will be described.

### Variation 1

In the above-described example embodiment, it has been explained that the user is able to identify himself or herself by the acquired title in the online service. However, the user may identify himself or herself by qualifications, achievements, or the like that the user possesses in the online service. For example, an SBT may be issued for a real qualification such as a doctor or a lawyer, or for an achievement such as attending a soccer school, and the user may express the possession of such qualifications or achievements for which the SBT has been issued in a metaverse space or the like.

In this case, the token management server 10 acquires a certificate that proves qualifications such as a doctor or a lawyer, and if the acquired certificate is legitimate, issues a corresponding SBT. Alternatively, the token management server 10 may verify a membership card or the like issued by a soccer school and verify the user's achievement of attending the soccer school.

### Variation 2

The service server 20 may provide a service according to whether or not the user owns a predetermined title. For example, in a case where the user owns a specific title, the metaverse server may allow the purchase of special items or the like that can be used in the metaverse space. For example, the metaverse server may prepare 3D items or the like that can be purchased only by users who have reached a predetermined level in the game.

### Variation 3

The metaverse server (the service server 20-4) may create a space in which many users having the same SBT (the same title, the same level) stay. For example, the metaverse server may create a space that allows entry only to users having the same SBT. Alternatively, the metaverse server may create a space in which users having the same SBT (the same title; for example, a title indicating that the same animation program has been viewed in all episodes) are displayed in a glowing manner.

### Variation 4

Alternatively, the metaverse server (the service server 20-4) may perform matching conducted in the metaverse space by using the titles (SBTs) owned by the users. For example, the metaverse server may preferentially perform matching (conversation pairing) among users who have the same type of title (a common title). At that time, the metaverse server may display the title used for matching (the title common among the users) in a form recognizable by both users. Alternatively, the metaverse server may display by default the SBTs (titles) owned by each user.

### Variation 5

The metaverse server may provide a function for searching, among a plurality of users staying in the same metaverse space, users having the same type or the same category of SBT (title). For example, the metaverse server may display, from a list of user names, users who own the target SBT (title) to be searched. Alternatively, the metaverse server may perform control for highlighting (for example, making glow) the user (avatar of the user) having the target SBT to be searched.

### Variation 6

The utilization of the SBTs in the above metaverse space is also applicable to other online services. For example, in a streaming service, in a case where a user sends a chat message to a person who is streaming a program related to a predetermined game, the video streaming server (the service server 20-3) may allow the comment to be sent using a color icon recognizable by third parties, in a state where a title proving that the user has achieved a predetermined rating or higher in online matches of the predetermined game is certified.

### Variation 7

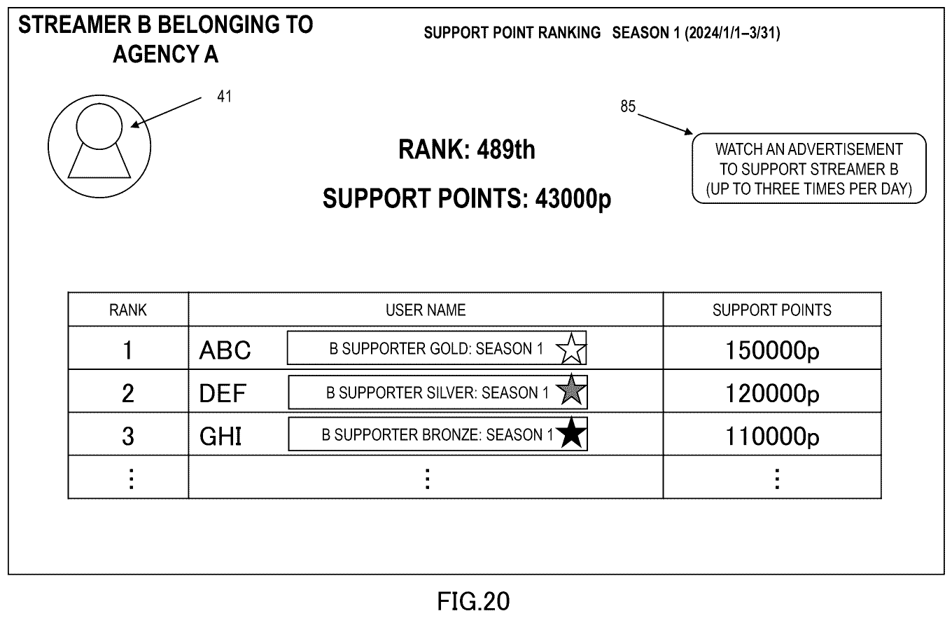

The video sharing server (service server 20-2) may provide advertisements for allowing users to support streamers. In this case, as shown in FIG. 20, the video sharing server displays an advertisement button 85.

In a case where the user presses the advertisement button 85, the video sharing server distributes an advertisement. A user who views the distributed advertisement is granted support points for the streamer. In addition, the video sharing server may determine the content of the advertisement to be distributed in accordance with the SBT owned by the user. It should be noted that a limit may be set on the number of advertisement distributions (support point grants) (for example, up to three times per day as shown in FIG. 20).

The video sharing server may select an advertisement to be distributed in accordance with the title (SBT) acquired by the user. For example, in a case where the user has acquired a title such as “Anime Program A: All Episodes Viewed,” the video sharing server distributes an advertisement related to Anime Program A. In addition, the video streaming server may visualize the SBT (title) used for the advertisement selection in a manner recognizable to the user during the distribution of the advertisement. In addition, the video sharing server may grant support points to the user in a case where the user presses a link or fully views the advertisement video. In addition, all or part of the advertisement fee paid as a result of the user's viewing of the advertisement may be returned to the rights holder corresponding to the SBT on which the advertisement selection is based (for example, the production company of Anime Program A in the above example).

### Variation 8

The token management server 10 may include various functions related to SNSs (social networking services). The token management server 10 may include functions as an SNS server.

The token management server 10 may allow a user, at the time of posting, to select whether or not the posted content is related to a predetermined IP (intellectual property). For example, the name of the IP for which the user holds an SBT may be displayed above a post message or the like. Alternatively, the related IP may be searchable. In addition, in a case where an IP is selected (that is, the post is related to the IP), the token management server 10 may assign a tag of the IP name separately from the post content in a manner allowing the user to visually recognize it at the time the user's post is displayed on the timeline. The IP tags may have a hierarchical structure; for example, a tag “Game A1” may exist below a tag “Game A.”

The token management server 10 may cause all images posted on the SNS to be previewed on the timeline in a state where a digital watermark (watermark filter) is applied. Furthermore, in a case where a detailed display of an image is requested by the user selecting the image, the token management server 10 may display a popup advertisement. The token management server 10 may display the image in full quality without a watermark after the user finishes viewing the advertisement.

In a case where an image is posted and the image is a derivative work, the user selects the original IP tag of the work. The advertisement revenue generated at the time of displaying the derivative image may be returned to the IP holder.

The token management server 10 may always cause the poster, at the time of posting an image, to select whether or not the image is an AI-generated image (including an image originally generated by AI even if manually modified). In a case where the image is selected as an AI-generated image, the token management server 10 may forcibly attach a tag indicating this fact to the posted image. Alternatively, in a case where the image is selected as not being AI-generated but a predetermined number or more of reports of suspected AI generation are received, the token management server 10 may request the poster to submit evidence that the image is not AI-generated (for example, layer information at the time of illustration creation or the like). The token management server 10 may keep the posted image hidden until the evidence is submitted. In a case where proper evidence is submitted (verification in this case may be performed either manually or by AI), the token management server 10 may attach a tag to the posted image indicating that it is confirmed not to be AI-generated. Alternatively, the token management server 10 may provide a button that allows AI-generated images to be excluded from search results with a single tap.

The token management server 10 may allow a user, at the time of posting a message or the like, to select a destination SBT for the post. For example, the token management server 10 may allow the user to post a message that is displayed on the timeline only to SNS users who own at least one SBT related to a specific IP. In addition, before the post content is displayed, destination information may be displayed separately from the post content in a visually recognizable manner.

The token management server 10 may apply a filter to the timeline. In a case where the user selects an IP name, the token management server 10 may display only posts or messages to which the corresponding IP tag is attached. Alternatively, in a case where the user selects an SBT, the token management server 10 may display only the posts of SNS users who own the SBT. In addition, the token management server 10 manages the display history for each filter. Furthermore, the user may register a predetermined number of favorite filters.

The token management server 10 may provide a trend word function. The trend word function may extract trends based on IP tags and SBTs instead of by text string aggregation. The token management server 10 may display a trend ranking for each IP.

The token management server 10 may provide a “recommended for you” function that displays posts from users other than those followed by the user. In this recommendation function, it may be possible to specify an IP also at the time of searching posts selected based on the SBTs owned by the user. For example, in a normal search for “Yamada,” Yamadas from various fields (industries or business sectors) are displayed. However, in a case where the user selects the IP “Game B” or selects “Game B” as an SBT while searching for “Yamada,” the likelihood increases that information related to Mr. Yamada, who is involved in Game B, will be provided.

### Variation 9

The token management server 10 may include a function for updating SBTs. In this case, the my page control unit 304 periodically logs into the user's account by using the login information of the service server 20.

For example, in a case where among the SBTs owned by the user there exists an SBT that originates from a game provided by a game server, the my page control unit 304 acquires information corresponding to the SBT (from play history or the like accumulated in the account of the game server). The my page control unit 304 updates the SBT (reissues the SBT) in a case where there exists an updatable title (user information corresponding to the title) among the titles corresponding to the SBT.

For example, in a case where the strength (level) of a character set in an SBT is not at the maximum level before accessing the game server but reaches the maximum level as the game progresses, the my page control unit 304 issues a title such as “Level MAX” related to the strength of the SBT.

### Variation 10

In the above example embodiment, the token management server 10 is described as issuing an SBT as means for certifying titles or the like acquired by a user. However, the token management server 10 may certify the user's titles by using other means.

Specifically, the token management server 10 may issue a digital certificate using a public key infrastructure (PKI; Public Key Infrastructure) as a title acquisition certificate. Alternatively, the token management server 10 may issue a credential certificate (VCs; Verifiable Credentials), the content of which can be verified online, as a title acquisition certificate.

In addition, in a case where a digital certificate using PKI or a credential certificate is issued as a title acquisition certificate, these certificates may be managed by the user's wallet or by an account of the token management server 10.

### Variation 11

A system configuration shown in FIG. 3 is an example. For example, the token management server 10 may provide a wallet service. That is, the token management server 10 may include functions of a wallet server.

As described above, the token management server 10 issues an SBT corresponding to a title or the like acquired by a user through an online service. A user who has received the issuance of an SBT can assert the acquired title to a third party. By receiving the issuance of an SBT, the user can, for example, claim in a metaverse space or the like a title acquired through playing an online game. In other words, the metaverse server can display the title of the user together with an avatar or the like. Such display is expected to make communication in the metaverse space smoother and more active.

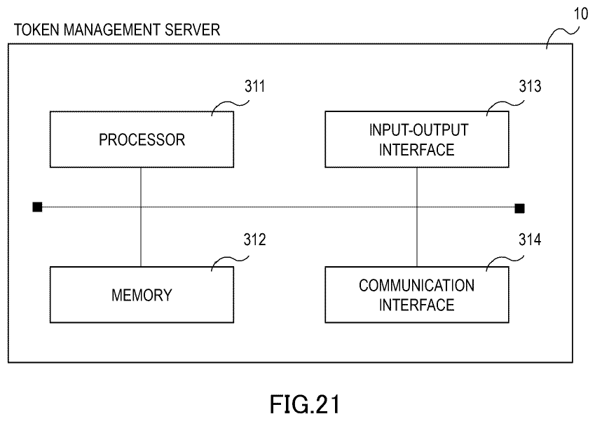

Next, a hardware configuration of an individual apparatus that constitutes the information processing system will be described. FIG. 21 is a diagram illustrating an example of the hardware configuration of the token management server 10.

The token management server 10 can be configured by an information processing apparatus (a so-called computer) and has a configuration illustrated as an example in FIG. 21. For example, The token management server 10 includes a processor 311, a memory 312, an input-output interface 313, a communication interface 314 or the like. The above-described components such as the processor 311 are connected via an internal bus or the like and are configured to be capable of communicating with each other.

However, the configuration shown in FIG. 21 is not intended to limit the hardware configuration of the token management server 10. The token management server 10 may include hardware not illustrated in the figure, and may omit the input-output interface 313 as needed. In addition, the number of components such as the processor 311 included in The token management server 10 is not intended to be limited to the example shown in FIG. 21, and, for example, a plurality of processors 311 may be included in the token management server 10.

For example, the processor 311 is a programmable device such as a CPU (Central Processing Unit), an MPU (Micro Processing Unit), or a DSP (Digital Signal Processor). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), or the like. The memory 312 stores an OS program, an application program, and various kinds of data.

The input-output interface 313 is an interface for a display apparatus and an input apparatus not illustrated. The display apparatus is, for example, a liquid crystal display or the like. For example, the input apparatus is an apparatus that receives a user operation such as a keyboard or a mouse.

The communication interface 314 is a circuit, a module, or the like for performing communication with other apparatuses. For example, the communication interface 314 includes a NIC (Network Interface Card) or the like.

The functions of the token management server 10 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present disclosure can be embodied as a computer program product. In addition, the above program may be updated by downloading a program via a network or by using a storage medium in which a program is stored. In addition, the above processing modules may be realized by semiconductor chips.

It should be noted that the service server 20 and the like can also be configured by an information processing apparatus similar to the token management server 10, and since their basic hardware configurations are not different from that of the token management server 10, a detailed description thereof will be omitted.

The token management server 10, which is an information processing apparatus, includes a computer, and the functions of the token management server 10 can be realized by causing the computer to execute a program. In addition, the token management server 10 executes a control method of the token management server 10 by using this program. Similarly, the service server 20 is equipped with a computer, and the functions of the service server 20 can be realized by executing a program on the computer. In addition, the service server 20 executes a control method of the service server 20 by using the program.

### Variations

It should be noted that the configuration and operation or the like of the information processing system described in the above example embodiment are merely illustrative, and are not intended to limit the configuration or the like of the system.

In the above example embodiment, a case is described in which the service server 20 acquires an SBT owned by a user through the token management server 10. However, the service server 20 may directly access the user's wallet and acquire the SBT owned by the user.

In the above example embodiment, a case is described in which the token management server 10 determines whether or not the user has acquired a title (whether or not the issuance of an SBT is possible). However, the service server 20 may determine whether or not a title can be granted based on the user information stored in the account. In a case where the granting of a title is possible, the service server 20 transmits information related to the grantable title (for example, the name of the service and the specific content of the title) and the user's wallet address to the token management server 10. The token management server 10, as necessary, inquires of the user whether the issuance of the SBT is required, and issues the SBT in a case where the user wishes the issuance of the SBT.

In the above example embodiment, a case is described in which the token management server 10 issues an SBT that the user desires to be issued. However, the token management server 10 may issue an SBT for each of the titles acquired by the user.

There is no limitation on the number of SBTs (titles that assert ownership) that one user can use in an online service. The user may use one SBT in an online service or may use a plurality of SBTs in an online service. It is of course acceptable that the SBTs (titles) used differ depending on each online service.

In the above example embodiment, a case is described in which an SBT is issued based on user information accumulated in the service server 20. However, an SBT may be issued based on user information accumulated in the token management server 10. For example, the token management server 10 may grant the user a title corresponding to the amount of NFT transactions or the like (for example, a title such as “NFT Transaction Amount No. 1: Season 1”) and issue a corresponding SBT.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present disclosure has been made apparent by the above description. That is, the present disclosure is suitably applicable, for example, to an information processing system or the like that enables a user to claim a title acquired by the user in an online service.

A part or the entirety of the example embodiments described above may be described as in the following supplementary notes, but is not limited to the followings.

### Supplementary Note 1

A user information SBT-ing apparatus including:
an issuing means that issues to a user as an owner, based on user information, the user information being information generated by a first server that provides a first service and related to a situation of the user who receives the first service, an SBT (SoulBound Token) corresponding to the user information; and
a guaranteeing means that enables a second server, the second server providing a second service, to perform a display guaranteeing that the user owns the SBT.

### Supplementary Note 2

The user information SBT-ing apparatus according to supplementary note 1, wherein the guaranteeing means enables the second server to display a guarantee that the SBT is officially recognized by a service provider that provides the first service.

### Supplementary Note 3

The user information SBT-ing apparatus according to supplementary note 2, wherein the guaranteeing means transmits the SBT owned by the user to the second server in response to a request from the second server.

### Supplementary Note 4

The user information SBT-ing apparatus according to supplementary note 3, wherein the SBT proves that the user owns a title acquired by receiving the first service.

### Supplementary Note 5

The user information SBT-ing apparatus according to supplementary note 4, further including a display means that displays at the least one or more SBTs owned by the user.

### Supplementary Note 6

The user information SBT-ing apparatus according to any one of supplementary notes 1 to 5, wherein the first service includes at least one of an online game service, a video sharing service, a video streaming service, and a metaverse service.

### Supplementary Note 7

The user information SBT-ing apparatus according to any one of supplementary notes 1 to 5, wherein the second service includes a metaverse service.

### Supplementary Note 8

A system including:
a first server that provides a first service;
a second server that provides a second service; and
a user information SBT-ing apparatus, and
wherein the user information SBT-ing apparatus includes:
an issuing means that issues to a user as an owner, based on user information, the user information being information generated by the first server and related to a situation of the user who receives the first service, an SBT (SoulBound Token) corresponding to the user information; and
a guaranteeing means that enables the second server to perform a display guaranteeing that the user owns the SBT.

### Supplementary Note 9

The system apparatus according to supplementary note 8, wherein the guaranteeing means enables the second server to display a guarantee that the SBT is officially recognized by a service provider that provides the first service.

### Supplementary Note 10

The system according to supplementary note 9, wherein the guaranteeing means transmits the SBT owned by the user to the second server in response to a request from the second server.

### Supplementary Note 11

The system according to supplementary note 10, wherein the SBT proves that the user owns a title acquired by receiving the first service.

### Supplementary Note 12

The system according to supplementary note 11, further including a display means that displays at the least one or more SBTs owned by the user.

### Supplementary Note 13

The system according to any one of supplementary notes 8 to 12, wherein the first service includes at least one of an online game service, a video sharing service, a video streaming service, and a metaverse service.

### Supplementary Note 14

The system according to any one of supplementary notes 8 to 12, wherein the second service includes a metaverse service.

### Supplementary Note 15

A control method of a user information SBT-ing apparatus, the control method including:
an issuing step that issues to a user as an owner, based on user information, the user information being information generated by a first server that provides a first service and related to a situation of the user who receives the first service, an SBT (SoulBound Token) corresponding to the user information; and
a guaranteeing step that enables a second server, the second server providing a second service, to perform a display guaranteeing that the user owns the SBT.

### Supplementary Note 16

The control method of the user information SBT-ing apparatus according to supplementary note 15, wherein the guaranteeing step enables the second server to display a guarantee that the SBT is officially recognized by a service provider that provides the first service.

### Supplementary Note 17

The control method of the user information SBT-ing apparatus according to supplementary note 16, wherein the guaranteeing step transmits the SBT owned by the user to the second server in response to a request from the second server.

### Supplementary Note 18

The control method of the user information SBT-ing apparatus according to supplementary note 17, wherein the SBT proves that the user owns a title acquired by receiving the first service.

### Supplementary Note 19

The control method of the user information SBT-ing apparatus according to supplementary note 18, further including a display step that displays at the least one or more SBTs owned by the user.

### Supplementary Note 20

The control method of the user information SBT-ing apparatus according to any one of supplementary notes 15 to 19, wherein the first service includes at least one of an online game service, a video sharing service, a video streaming service, and a metaverse service.

### Supplementary Note 21

The control method of the user information SBT-ing apparatus according to any one of supplementary notes 15 to 19, wherein the second service includes a metaverse service.

### Supplementary Note 22

A program causing a computer mounted on a user information SBT-ing apparatus to perform processing for:
an issuing processing that issues to a user as an owner, based on user information, the user information being information generated by a first server that provides a first service and related to a situation of the user who receives the first service, an SBT (SoulBound Token) corresponding to the user information; and
a guaranteeing processing that enables a second server, the second server providing a second service, to perform a display guaranteeing that the user owns the SBT.

### Supplementary Note 23

The program according to supplementary note 22, wherein the guaranteeing processing enables the second server to display a guarantee that the SBT is officially recognized by a service provider that provides the first service.

### Supplementary Note 24

The program according to supplementary note 23, wherein the guaranteeing processing transmits the SBT owned by the user to the second server in response to a request from the second server.

### Supplementary Note 25

The program apparatus according to supplementary note 24, wherein the SBT proves that the user owns a title acquired by receiving the first service.

### Supplementary Note 26

The program according to supplementary note 25, further performing a display processing that displays at the least one or more SBTs owned by the user.

### Supplementary Note 27

The program according to any one of supplementary notes 22 to 26, wherein the first service includes at least one of an online game service, a video sharing service, a video streaming service, and a metaverse service.

### Supplementary Note 28

The program according to any one of supplementary notes 22 to 26, wherein the second service includes a metaverse service.

In addition, a part or all of the configurations described in supplementary notes 2 to 7, which are dependent on supplementary note 1 described above, may also be dependent on supplementary notes 8, 15, and 22 through the same dependent relationship as that between supplementary notes 2 to 7 and supplementary note 1. In addition, not limited to supplementary notes 1, 8, 15, and 22, a part or all of the configurations described as supplementary notes may likewise be made dependent on various hardware, software, various recording means for recording software, or systems, within a range that does not depart from the above-described example embodiments.

The entire disclosure of the above patent literature is incorporated herein by reference thereto. While the example embodiments of the present disclosure have thus been described, the present disclosure is not limited to these example embodiments. It is to be understood to those skilled in the art that these example embodiments are only examples and that various variations are possible without departing from the scope and spirit of the present disclosure. That is, the present disclosure of course includes various variations and modifications that could be made by those skilled in the art in accordance with the overall disclosure including the claims and the technical concept.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents. Further, it is noted that the inventor's intent is to retain all equivalents of the claimed disclosure even if the claims are amended during prosecution.

What is claimed is:

1. A user information SBT-ing apparatus comprising:
at least one memory storing a set of instructions; and
at least one processor configured to execute the set of instructions to:
issue to a user as an owner, based on user information, the user information being information generated by a first server that provides a first service and related to a situation of the user who receives the first service, an SBT (SoulBound Token) corresponding to the user information; and
enable a second server, the second server providing a second service, to perform a display guaranteeing that the user owns the SBT.

2. The user information SBT-ing apparatus according to claim 1, wherein
the at least one processor is further configured to execute the set of instructions to enable the second server to display a guarantee that the SBT is officially recognized by a service provider that provides the first service.

3. The user information SBT-ing apparatus according to claim 2, wherein
the at least one processor is further configured to execute the set of instructions to transmit the SBT owned by the user to the second server in response to a request from the second server.

4. The user information SBT-ing apparatus according to claim 3, wherein the SBT proves that the user owns a title acquired by receiving the first service.

5. The user information SBT-ing apparatus according to claim 4, wherein
the at least one processor is further configured to execute the set of instructions to display at the least one or more SBTs owned by the user.

6. The user information SBT-ing apparatus according to claim 1, wherein the first service includes at least one of an online game service, a video sharing service, a video streaming service, and a metaverse service.

7. The user information SBT-ing apparatus according to claim 2, wherein the first service includes at least one of an online game service, a video sharing service, a video streaming service, and a metaverse service.

8. The user information SBT-ing apparatus according to claim 3, wherein the first service includes at least one of an online game service, a video sharing service, a video streaming service, and a metaverse service.

9. The user information SBT-ing apparatus according to claim 4, wherein the first service includes at least one of an online game service, a video sharing service, a video streaming service, and a metaverse service.

10. The user information SBT-ing apparatus according to claim 5, wherein the first service includes at least one of an online game service, a video sharing service, a video streaming service, and a metaverse service.

11. The user information SBT-ing apparatus according to claim 1, wherein the second service includes a metaverse service.

12. A system comprising:
a first server that provides a first service;
a second server that provides a second service; and
a user information SBT-ing apparatus, and
wherein the user information SBT-ing apparatus comprises:
at least one memory storing a set of instructions; and
at least one processor configured to execute the set of instructions to:
issue to a user as an owner, based on user information, the user information being information generated by the first server and related to a situation of the user who receives the first service, an SBT (SoulBound Token) corresponding to the user information; and
enable the second server to perform a display guaranteeing that the user owns the SBT.

13. A control method of a user information SBT-ing apparatus, the control method comprising:
issuing to a user as an owner, based on user information, the user information being information generated by a first server that provides a first service and related to a situation of the user who receives the first service, an SBT (SoulBound Token) corresponding to the user information; and
enabling a second server, the second server providing a second service, to perform a display guaranteeing that the user owns the SBT.

14. A non-transitory computer-readable storage medium storing a program causing a computer mounted on a user information SBT-ing apparatus to perform processing for:
issuing to a user as an owner, based on user information, the user information being information generated by a first server that provides a first service and related to a situation of the user who receives the first service, an SBT (SoulBound Token) corresponding to the user information; and
enabling a second server, the second server providing a second service, to perform a display guaranteeing that the user owns the SBT.
